(19) United States
(12) Patent Application Publication
(10) Pub. No.: US 2017/0150126 A1
(43) Pub. Date: May 25, 2017

(54) PHOTOGRAPHING DEVICE AND OPERATING METHOD OF THE SAME

(71) Applicant: SAMSUNG ELECTRONICS CO., LTD., Suwon-si (KR)

(72) Inventor: Il-do KIM, Bucheon-si (KR)

(21) Appl. No.: 15/158,635

(22) Filed: May 19, 2016

(30) Foreign Application Priority Data
Nov. 23, 2015 (KR) 10-2015-0163985

(51) Int. Cl. H04N 13/02; H04N 5/232; G03B 13/36; H04N 5/225

(52) U.S. Cl. CPC H04N 13/0271; H04N 13/0239; H04N 5/2253; H04N 5/2254; H04N 5/2257; H04N 5/23212; G03B 13/36

(57) ABSTRACT

A photographing device is disclosed that includes a first camera module and second camera module configured to photograph a same subject, a temperature sensor configured to measure a temperature of the first camera module, and a controller configured to determine a disparity between a first image acquired from the first camera module and a second image acquired from the second camera module and to perform an auto-focusing of the first camera module based on the disparity and the temperature of the first camera module.

### CROSS-REFERENCE TO RELATED APPLICATION

This application is based on and claims priority under 35 U.S.C. §119 to Korean Patent Application No. 10-2015-0163985, filed on Nov. 23, 2015, in the Korean Intellectual Property Office, the disclosure of which is incorporated by reference herein in its entirety.

### BACKGROUND

1. Field

The present disclosure relates to a photographing device and an operating method of the same, and for example, to a photographing device which performs auto-focusing and an operating method of the same.

2. Description of Related Art

A multi-camera system may include two or more camera modules and detects a focus of a particular object or generates a three-dimensional (3D) image using images input from the respective camera modules.

In particular, methods of automatically detecting a focus in the multi-camera system may be classified into three types. In the first-type method, each camera module separately performs an auto-focusing, and in the second-type method, only the main camera module performs an auto-focusing and other sub-camera modules use the auto-focusing result of the main camera module. In the third-type method, a disparity calculated from two images separately input from two camera modules is analyzed to perform auto-focusing of each of the two camera modules. For example, the multi-camera system may detect where an object displayed in a particular position in one image is displayed in another image and extract a disparity between the two positions. Using the disparity of the two positions, the multi-camera system may calculate a distance value from a particular object and focus on the particular object.

### SUMMARY

A photographing device capable of auto-focusing taking into consideration of a disparity between images taken by two camera modules and temperatures or humidities of the camera modules, and an operating method of the same are provided.

Additional aspects will be set forth in part in the description which follows and, in part, will be apparent from the description.

According to an aspect of an example embodiment, a photographing device includes a first camera module comprising a camera and second camera module comprising a camera, the first and second camera modules configured to photograph a same subject, a temperature sensor configured to measure a temperature of the first camera module, and a controller configured to determine a disparity between a first image acquired from the first camera module and a second image acquired from the second camera module and to perform auto-focusing of the first camera module based on the disparity and the temperature of the first camera module.

The controller according to the example embodiment may be configured to perform the auto-focusing to focus the first camera module on the subject.

The first camera module according to the example embodiment may include a focus lens, and the temperature of the first camera module may be a temperature of the focus lens.

The controller according to the example embodiment may be configured to determine a first position of the focus lens corresponding to the disparity, to determine a second position of the focus lens by performing temperature compensation of the first position based on the temperature of the first camera module, and to control the first camera module to move the focus lens to the second position.

The photographing device according to the example embodiment may further include a storage configured to store a disparity map representing a relationship between the disparity and a position of the focus lens, and a temperature map representing a relationship between the position of the focus lens and the temperature of the first camera module, and the controller may be configured to determine the first position corresponding to the disparity using the disparity map and to convert the first position to the second position using the temperature map.

The focus lens according to the example embodiment may include a plastic lens.

The controller according to the example embodiment may be configured to compare the temperature of the first camera module with a threshold range, may be configured to determine a position of the focus lens based on the disparity when the temperature of the first camera module is included in the threshold range, and may be configured to acquire a plurality of images while changing the position of the focus lens and to determine the position of the focus lens based on contrasts of the plurality of images when the temperature of the first camera module is not included in the threshold range.

When the temperature of the first camera module is not included in the threshold range, the controller according to the example embodiment may be configured to determine a first position of the focus lens based on the disparity, to acquire the plurality of images while changing the position of the focus lens within a certain range determined based on the first position, and to determine a second position of the focus lens based on contrasts of the plurality of images.

The photographing device according to the example embodiment may further include a humidity sensor configured to measure humidity of the first camera module, and the controller may be configured to perform the auto-focusing of the first camera module based on the disparity and the humidity of the first camera module.

According to an aspect of another example embodiment, a method of operating a photographing device includes acquiring a first image of a subject from a first camera module and acquiring a second image of the subject from a second camera module, determining a disparity between the first image and the second image, measuring a temperature of the first camera module, and performing auto-focusing of the first camera module based on the disparity and the temperature of the first camera module.

The performing of the auto-focusing of the first camera module according to the other example embodiment may include focusing the first camera module on the subject.

The first camera module according to the other example embodiment may include a focus lens, and the measuring of the temperature of the first camera module may include measuring a temperature of the focus lens.

The performing of the auto-focusing of the first camera module according to the other example embodiment may include determining a first position of the focus lens corresponding to the disparity, determining a second position of the focus lens by performing temperature compensation of the first position based on the temperature of the first camera module, and moving the focus lens to the second position.

The method of operating the photographing device according to the other example embodiment may further include storing a disparity map representing a relationship between the disparity and a position of the focus lens and a temperature map representing a relationship between the position of the focus lens and the temperature of the first camera module, the determining of the first position may include determining the first position corresponding to the disparity using the disparity map, and the determining of the second position may include converting the first position to the second position using the temperature map.

The performing of the auto-focusing of the first camera module according to the other example embodiment may include comparing the temperature of the first camera module with a threshold range, determining a position of the focus lens based on the disparity when the temperature of the first camera module is within in the threshold range, and when the temperature of the first camera module is not within the threshold range, acquiring a plurality of images while changing the position of the focus lens and determining the position of the focus lens based on contrasts of the plurality of images.

When the temperature of the first camera module is not included in the threshold range, the determining of the position of the focus lens according to the other example embodiment may include determining a first position of the focus lens based on the disparity, and acquiring the plurality of images while changing the position of the focus lens within a certain range determined based on the first position and determining a second position of the focus lens based on contrasts of the plurality of images.

The operating method of the photographing device according to the other example embodiment may further include measuring a humidity of the first camera module, and performing the auto-focusing of the first camera module based on the disparity and the humidity of the first camera module.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1A is a diagram illustrating an example multi-camera system including a plurality of camera modules;

FIG. 1B are diagrams illustrating an example method of detecting a disparity in a multi-camera system;

FIGS. 2A and 2B are graphs illustrating a position of a focus lens according to temperature and illustrating a position of a focus lens according to humidity, respectively;

FIG. 3A is a block diagram illustrating an example configuration of a photographing device;

FIG. 3B is a block diagram illustrating an example configuration of a first camera module of FIG. 3A;

FIG. 4 is a block diagram illustrating an example configuration of a photographing device;

FIG. 5 is a block diagram illustrating an example configuration of a photographing device;

FIG. 6 is a flowchart illustrating an example method of a photographing device performing auto-focusing;

FIG. 7 is a flowchart illustrating operation 640 (S640) of FIG. 6 in greater detail;

FIG. 8 is a graph illustrating an example position of a focus lens determined using a depth auto-focus scheme and a position of a focus lens determined using a contrast auto-focus scheme with respect to a subject which is a constant distance away from a camera module based on the temperature of the camera module;

FIG. 9 is a flowchart illustrating an example method of a photographing device performing auto-focusing; and

FIG. 10 is a flowchart illustrating an example method of a photographing device performing auto-focusing.

### DETAILED DESCRIPTION

Terminology used in this description will be described briefly, and example embodiments of the present disclosure will be described in greater detail.

For the terminology used in this description, general terms currently in wide use are selected wherever possible in consideration of functions in the present disclosure, but may vary according to intentions of those of ordinary skill in the art, precedent cases, the advent of new technology, and so on. For example, some terms may be arbitrarily selected, and in such cases, the meanings of the terms may be stated in the corresponding description. Therefore, the terms used in this description should be defined based on the meanings of the terms together with the description throughout the disclosure rather than their simple names.

Throughout the description, when a portion “includes” an element, unless otherwise described, another element may be further included, rather than the presence of other elements being excluded. Also, terms such as “portion,” “module,” etc. used herein indicate a unit for processing at least one function or operation, in which the unit and the block may be embodied as hardware (e.g., circuitry), firmware or software or may be embodied by a combination of hardware and software.

Reference will now be made in greater detail to example embodiments, examples of which are illustrated in the accompanying drawings, wherein like reference numerals refer to like elements throughout. In this regard, the present example embodiments may have different forms and should not be construed as being limited to the descriptions set forth herein. Accordingly, the example embodiments are described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

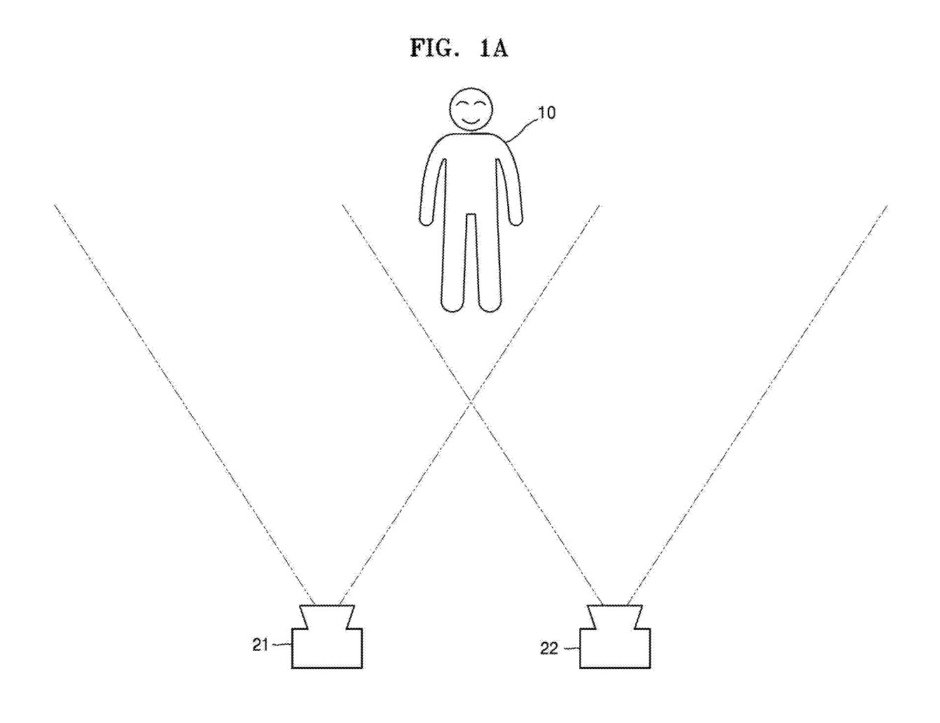

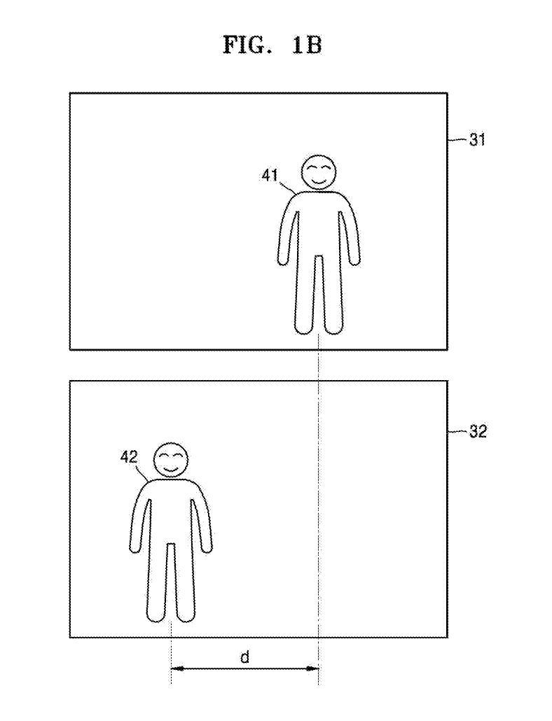

FIG. 1A is a diagram illustrating an example multi-camera system including a plurality of camera modules, and FIG. 1B includes diagrams illustrating an example method of detecting a disparity in a multi-camera system.

A multi-camera system may, for example, be a stereoscopic camera which generates a three-dimensional (3D) image. The multi-camera system may include a first camera module 21 and a second camera module 22. For example, the first camera module 21 and the second camera module 22 may be disposed a certain distance apart from each other. The multi-camera system may detect a disparity using a first image acquired from the first camera module 21 and a second image acquired from the second camera module 22.

Determining the disparity will be described in greater detail below with reference to FIG. 1B.

Referring to FIG. 1B, a first image 31 is an image acquired from the first camera module 21, and a second image 32 is an image acquired from the second camera module 22. Even when the first camera module 21 and the second camera module 22 have the same optical characteristic, a position of a subject in the first image 31 differs from a position of the subject in the second image 32. For example, as illustrated in FIG. 1A, the first camera module 21 is disposed on a left side with respect to a subject 10, and thus a subject 41 included in the first image 31 is positioned on a right side with respect to the center line of the first image 31. Also, as illustrated in FIG. 1A, the second camera module 22 is disposed on a right side with respect to the subject 10, and thus a subject 42 included in the second image 32 is positioned on a left side with respect to the center line of the second image 32.

Referring to FIG. 1B, the multi-camera system may detect a disparity d which corresponds to a difference between a position of the subject 41 included in the first image 31 and a position of the subject 42 included in the second image 32. Using the detected disparity d in a depth auto-focus scheme, the multi-camera system may perform auto-focusing of each of the first camera module 21 and the second camera module 22.

For example, the multi-camera system may acquire a position of a focus lens of the first camera module 21 and a position of a focus lens of the second camera module 22 corresponding to the disparity d calculated using the first image 31 and the second image 32. By moving the focus lenses included in the first camera module 21 and the second camera module 22 to the acquired focus lens positions, the multi-camera system may perform auto-focusing.

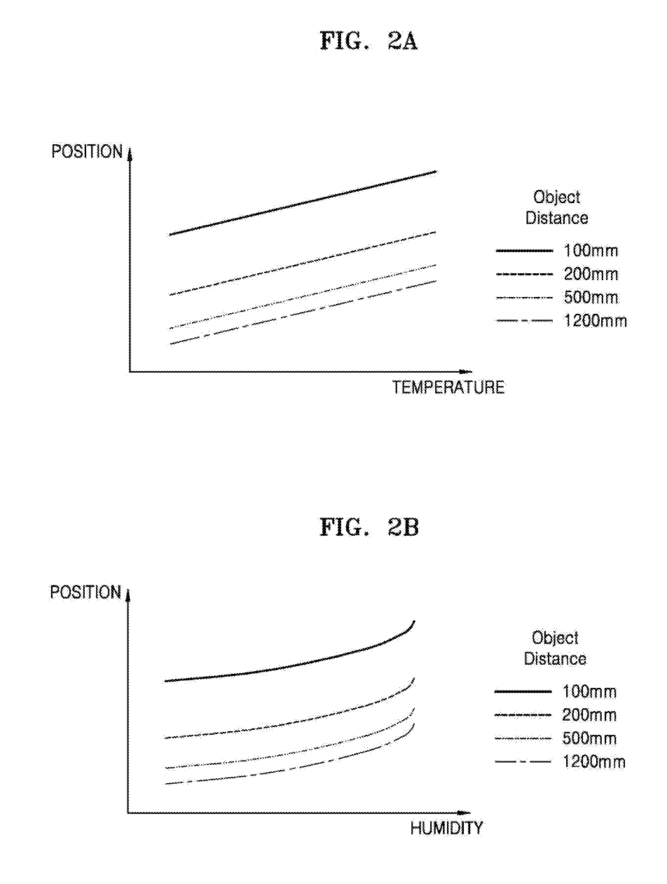

FIG. 2A, is a graph illustrating a position of a focus lens based on temperature, and FIG. 2B is a graph illustrating a position of a focus lens based on humidity.

The horizontal axis of the graph illustrated in FIG. 2A represents the temperature of a camera module (the temperature of a focus lens), and the vertical axis represents a position of the focus lens for focusing on a subject. The focal length of the camera module may be changed as the temperature of the camera module (the temperature of the focus lens) changes. Accordingly, the position of the focus lens for focusing on a subject may vary according to the temperature of the camera module even if the distance between the camera module and the subject is remains constant. When the position of the focus lens is determined based on the distance from the subject irrespective of a temperature change of the camera module, the subject may be out of focus. A photographing device according to an example embodiment may determine a position of a focus lens taking into consideration the temperature of a camera module.

The horizontal axis of the graph illustrated in FIG. 2B represents the humidity of a camera module (the humidity at a focus lens), and the vertical axis represents a position of the focus lens for focusing on a subject. Referring to FIG. 2B, the position of the focus lens for focusing on a subject may vary based on the humidity of the camera module even if the distance between the camera module and the subject is remains constant. When the position of the focus lens is determined based on the distance from the subject irrespective of a humidity change of the camera module, the subject may be out of focus. A photographing device according to an example embodiment may determine a position of a focus lens taking the humidity of a camera module as well as the temperature of the camera module into consideration.

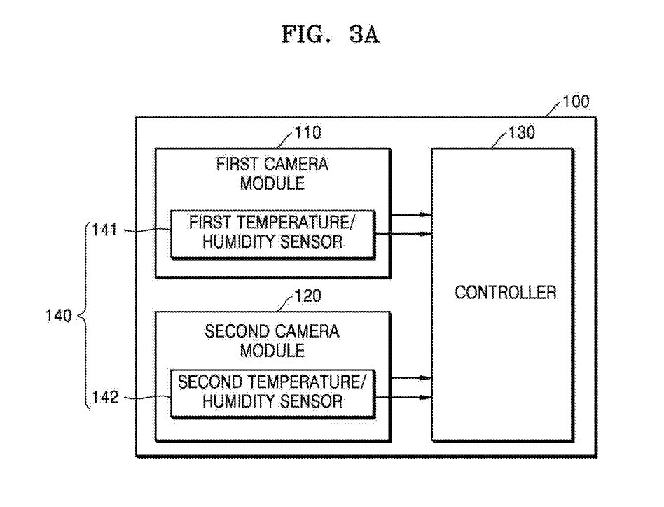

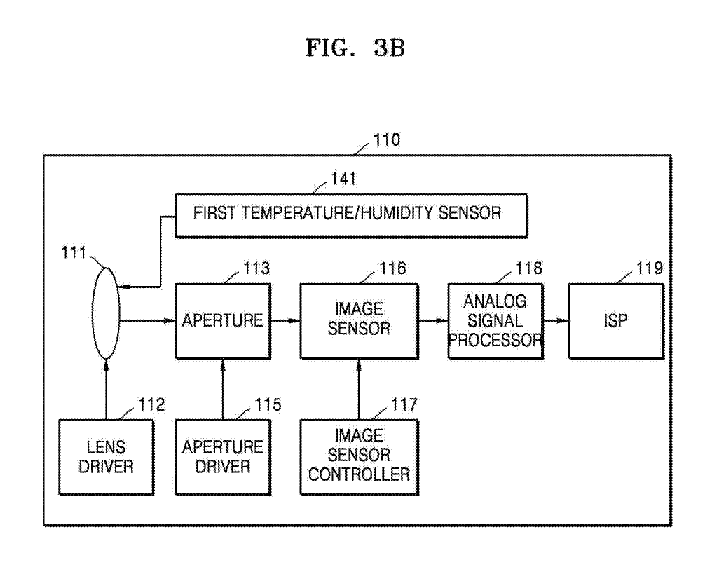

FIG. 3A is a block diagram illustrating an example configuration of a photographing device, and FIG. 3B is a block diagram illustrating an example configuration of a first camera module of FIG. 3A.

Referring to FIG. 3A, a photographing device 100 may include a first camera module (e.g., including a first camera) 110, a second camera module (e.g., including a second camera) 120, a temperature/humidity sensor 140, and a controller (e.g., including processing circuitry, such as, for example, a CPU, GPU, etc.) 130.

As described above with reference to FIG. 1A, the photographing device 100 according to an example embodiment may be implemented as a multi-camera system including a plurality of camera modules. The photographing device 100 may also be implemented in various forms, such as a digital still camera which takes a still image, a digital video camera which takes a video, and so on. The photographing device 100 may include a digital single-lens reflex (DSLR) camera, a mirrorless camera, or a smart phone, or the like. However, the photographing device 100 is not limited thereto, and may include a device in which a plurality of camera modules including a lens and an imaging element to photograph a subject and generate an image are installed.

The temperature/humidity sensor 140 may include a first temperature/humidity sensor 141 and a second temperature/humidity sensor 142. For example, the first camera module 110 may include the first temperature/humidity sensor 141, and the second camera module 120 may include the second temperature/humidity sensor 142.

The first temperature/humidity sensor 141 may measure one or more of the temperature and humidity of the first camera module 110. The first temperature/humidity sensor 141 may measure one or more of the temperature and humidity of a lens included in the first camera module 110. The second temperature/humidity sensor 142 may measure one or more of the temperature and humidity of the second camera module 120. For example, the second temperature/humidity sensor 142 may measure one or more of the temperature and humidity of a lens included in the second camera module 120.

FIG. 3A illustrates the temperature/humidity sensor 140 capable of measuring one or more of temperature and humidity, but the temperature/humidity sensor 140 is not limited thereto. The temperature/humidity sensor 140 may, for example, be separately implemented as a temperature sensor and a humidity sensor.

The first temperature/humidity sensor 141 may transmit one or more of the measured temperature and humidity of the first camera module 110 to the controller 130, and the second temperature/humidity sensor 142 may transmit one or more of the measured temperature and humidity of the second camera module 120 to the controller 130.

FIG. 3B is a block diagram illustrating an example configuration of the first camera module 110.

Referring to FIG. 3B, the first camera module 110 may include a lens 111, a lens driver 112, the first temperature/humidity sensor 141, an aperture 113, an aperture driver 115, an image sensor 116, an image sensor controller 117, an analog signal processor 118, and an image signal processor (ISP) 119.

The lens 111 may include a plurality of lenses in a plurality of groups. The lens 111 may include a focus lens, which may include a plastic lens. A position of the lens 111 may be adjusted by the lens driver 112. The lens driver 112 adjusts the position of the lens 111 based on a control signal provided by the controller 130. By adjusting a position of the focus lens, the lens driver 112 may adjust the focal length and perform operations such as auto-focusing, focus changing, and so on.

For example, the lens driver 112 may perform auto-focusing by adjusting the position of the focus lens based on the control signal provided by the controller 130.

The degree of opening or closing of the aperture 113 is adjusted by the aperture driver 115, and the aperture 113 adjusts the amount of light incident on the image sensor 116.

An optical signal transmitted through the lens 111 and the aperture 113 forms an image of a subject on a light-receiving surface of the image sensor 116. The image sensor 116 may be a charge-coupled device (CCD) image sensor or a complementary metal oxide semiconductor (CMOS) image sensor (CIS) which converts the optical signal into an electrical signal, or the like. The sensitivity, etc. of the image sensor 116 may be adjusted by the image sensor controller 117. The image sensor controller 117 may control the image sensor 116 based on a control signal automatically generated by an image signal which is input in real time or a control signal manually input by a user's manipulation.

The analog signal processor 118 performs noise reduction, gain adjustment, waveform standardization, analog-to-digital conversion, etc. on an analog signal supplied from the image sensor 116.

The ISP 119 is a signal processor for processing a special function on an image data signal processed by the analog signal processor 118. For example, the ISP 119 may reduce noise in input image data and perform image signal processing such as gamma correction, color filter array interpolation, color matrix, color correction, color enhancement, white balance adjustment, luminance smoothing, color shading, etc., for improving a picture quality and providing special effects. The ISP 119 may generate an image file by compressing input image data or restore the image data from the image file. A compression format of an image may be reversible or irreversible. As an example of an appropriate format, it is possible to convert a still image into a Joint Photographic Experts Group (JPEG) format, a JPEG 2000 format, and so on. Also, when a video is recorded, a video file may be generated by compressing a plurality of frames according to a Moving Picture Experts Group (MPEG) standard. The image file may be generated, for example, according to an exchangeable image file format (Exif) standard.

The ISP 119 may generate a video file from an imaging signal generated by the image sensor 116. The imaging signal may be a signal which is generated by the image sensor 116 and processed by the analog signal processor 118. The ISP 119 may generate frames to be included in a video file from the imaging signal, compress the frames by encoding the frames according to a standard such as MPEG4, H.264/Advanced Video Coding (AVC), Windows Media Video (WMV), etc., and then generate a video file using the compressed frames. The video file may be generated in a variety of formats such as mpg, mp4, 3gpp, avi, asf, mov, and so on. The ISP 119 may output the generated first image to the controller 130.

As with the first camera module 110, the second camera module 120 may also include a lens, a lens driver, a second temperature/humidity sensor, an aperture, an aperture driver, an image sensor, an image sensor controller, an analog signal processor, and an ISP. These elements have already been described with reference to the first camera module 110, and the descriptions will not be repeated.

The first camera module 110 and the second camera module 120 may have different optical characteristics. An optical characteristic of a camera module may be determined by one or more of the angle of view of a lens included in the camera module, the resolution of an image sensor included in the camera module, and the type of the image sensor included in the camera module. For example, the angle of view of the lens represents the angular coverage of an image (a photographic range) through the lens of the camera module. It is possible to photograph a wider range with a wider angle of view. Also, the resolution of an image sensor is determined by the number of pixels included in the image sensor. With an increase in the number of pixels included in an image sensor, the resolution of the image sensor increases.

The angle of view of a lens included in the first camera module 110 and the angle of view of a lens included in the second camera module 120 may differ from each other. For example, when a lens included in the first camera module 110 is a wide-angle lens and a lens included in the second camera module 120 is a telephoto lens, the first camera module 110 may photograph a wider range than the second camera module 120 because the wide-angle lens has a wider angle of view than the telephoto lens. When a lens included in any one of the first camera module 110 and the second camera module 120 is a zoom lens and a lens included in the other is a prime lens, the angle of view of the first camera module 110 and the angle of view of the second camera module 120 may differ from each other.

The resolution of the image sensor 116 included in the first camera module 110 and the resolution of the image sensor included in the second camera module 120 may differ from each other. For example, the resolution of the image sensor 116 included in the first camera module 110 may be lower than the resolution of the image sensor included in the second camera module 120, and the resolution of the image sensor included in the second camera module 120 may be higher than the resolution of the image sensor 116 included in the first camera module 110.

Further, the first camera module 110 may include a red, green, and blue (RGB) sensor to acquire a color image, and the second camera module 120 may include a monochrome sensor to acquire a black-and-white image.

The controller 130 may be configured to control the overall operation of the photographing device 100. The controller 130 may be configured to provide a control signal for operation of each element included in the photographing device 100 to the element.

The controller 130 may be configured to process an input image signal and to control each element based on the processed image signal or an external input signal. The controller 130 may correspond to one or more processors. The processors may be implemented as an array of a plurality of logic gates or a combination of a general-use microprocessor and a memory storing a program executable by the microprocessor. Those of ordinary skill in the art to which this embodiment pertains will appreciate that the processors may be implemented as hardware in other forms.

The controller 130 may be configured to execute a stored program. Alternatively, the controller 130 may have a separate module and generate a control signal for controlling auto-focusing, a zoom ratio change, a focus shift, automatic exposure correction, and so on. The controller 130 may be configured to provide the generated control signal to an aperture driver, a lens diver, and an image sensor controller included in each of the first camera module 110 and the second camera module 120. The controller 130 may be configured to collectively control operation of elements such as a shutter, a strobo, etc., provided in the photographing device 100.

The controller 130 may be connected to an external monitor and may be configured to perform certain image signal processing of an image signal input from an ISP included in the first camera module 110 or the second camera module 120 so that the image signal may be displayed on the external monitor. The controller 130 may be configured to transmit image data processed in this way, so that the corresponding image is displayed on the external monitor.

The controller 130 may be configured to determine a disparity using a first image and a second image acquired from the first camera module 110 and the second camera module 120, respectively. Based on the determined disparity and one or more of the temperature and humidity of the first camera module 110, the controller 130 may be configured to perform auto-focusing of the first camera module 110. Also, based on the determined disparity and one or more of the temperature and humidity of the second camera module 120, the controller 130 may be configured to perform auto-focusing of the second camera module 120.

The controller 130 may be configured to determine a first position of a focus lens corresponding to the determined disparity (the focus lens included in the first camera module 110). The controller 130 may also be configured to determine a second position by performing temperature compensation of the first position based only on the temperature of the first camera module 110. The controller 130 may be configured to control the focus lens to be moved to the second position, thereby performing auto-focusing of the first camera module 110. The controller 130 may be configured to perform auto-focusing of the second camera module 120 in the same or similar way.

The controller 130 may be configured to compare the temperature of the first camera module 110 with a threshold range and determine a position of the focus lens based on the determined disparity when the temperature of the first camera module 110 is included in the threshold range. On the other hand, when the temperature of the first camera module 110 is not in the threshold range, the controller 130 may be configured to acquire a plurality of images while changing the position of the focus lens and determine the position of the focus lens based on contrasts of the plurality of images. The controller 130 may also be configured to determine a position of the focus lens included in the second camera module 120 in the same or similar way.

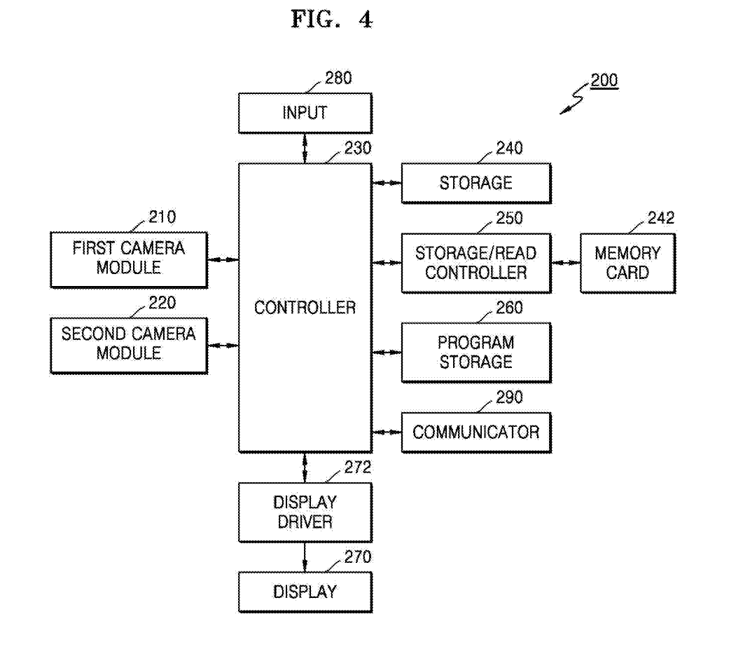

FIG. 4 is a block diagram illustrating an example configuration of a photographing device 200.

Referring to FIG. 4, the photographing device 200 may include a first camera module (e.g., including a first camera) 210, a second camera module (e.g., including a second camera) 220, a controller (e.g., including processing circuitry) 230, a storage (e.g., a memory) 240, a storage/read controller 250, a memory card 242, a program storage 260, a display (e.g., including a display panel) 270, a display driver 272, an input (e.g., including input circuitry, such as, for example, a button, a key, a touch panel, etc.) 280, and a communicator (e.g., including communication circuitry) 290. The first camera module 210 and the second camera module 220 may each include a temperature/humidity sensor.

Since the first camera module 210, the second camera module 220, and the controller 230 of FIG. 4 correspond to the first camera module 110, the second camera module 120, and the controller 130 of FIG. 3A respectively, the descriptions will not be repeated, and other elements will be described.

Referring to FIG. 4, the storage/read controller 250 may store image data output from the first camera module 210 or the second camera module 220 in the memory card 242. The storage/read controller 250 may store the image data automatically or based on a signal received from a user. The storage/read controller 250 may read data about an image from an image file stored in the memory card 242 and input the read data to the display driver 272 through the storage 240 or another route, so that an image may be displayed on the display 270.

The memory card 242 may be detachable or permanently installed in the photographing device 200. For example, the memory card 242 may be a flash memory card such as a secure digital (SD) card and so on.

Meanwhile, an image signal processed by the first camera module 210 or the second camera module 220 may be input to the controller 230 either through or not through the storage 240. The storage 240 may operate as a main memory of the photographing device 200 and temporarily store information for operation of the photographing device 200.

The storage 240 may store a disparity map. The disparity map may, for example, be a table showing positions of focus lenses (the focus lenses included in the first camera module 210 and the second camera module 220) each corresponding to each of a plurality of disparities. The positions of the focus lenses included in the disparity map may be positions measured during manufacturing of the photographing device 200, for example, positions of the focus lenses corresponding to temperature and humidity at which the manufacturing process is carried out. The disparity map may be in the form of a relational expression for converting a disparity into the position of the focus lens included in the first camera module 210 or a relational expression for converting a disparity into the position of the focus lens included in the second camera module 220. However, the disparity map is not limited thereto.

In addition, the storage 240 may store a temperature map. The temperature map may, for example, be a table for converting a determined position of a focus lens (e.g., a position of the focus lens corresponding to the temperature at which the manufacturing process is carried out) into a position of the focus lens corresponding to the current temperature. Further, the storage 240 may store a humidity map. The humidity map may, for example, be a table for converting a determined position of a focus lens (e.g., a position of the focus lens corresponding to the humidity at which the manufacturing process is carried out) into a position of the focus lens corresponding to the current humidity.

The program storage 260 may store programs, such as an operating system (OS) for running the photographing device 200, an application system, and so on.

The photographing device 200 may include the display 270 to display an operation state thereof or image information captured by the photographing device 200. The first camera module 210 and the second camera module 220 may process display image signals to display the captured image information on the display 270. For example, the first camera module 210 and the second camera module 220 may perform brightness level adjustment, color correction, contrast adjustment, contour emphasis adjustment, screen segmentation, generation of a character image and the like, image composition, etc. on the captured image information.

The display 270 may provide visual information to the user. The display 270 may be a liquid crystal display (LCD) panel, an organic light-emitting display panel, and so on. Also, the display 270 may be a touch screen capable of recognizing a touch input.

The display driver 272 provides a driving signal to the display 270.

The input 280 is an element into which a user may input a control signal. The input 280 may include a variety of function buttons such as a shutter-release button for inputting a shutter-release signal for photographing by exposing an image sensor to light for a determined time, a power button for inputting a control signal for controlling on/off of the power, a zoom button for widening or narrowing the angle of view according to an input, a mode selection button, buttons for adjusting other photographic setting values, and so on. The input 280 may be implemented in any form, such as buttons, a keyboard, a touch pad, a touch screen, a remote control, etc., through which the user may input a control signal.

The communicator 290 may include, for example, a network interface card (NIC), a modem, etc., and enable the photographing device 200 to communicate with an external device through a network in a wired or wireless manner.

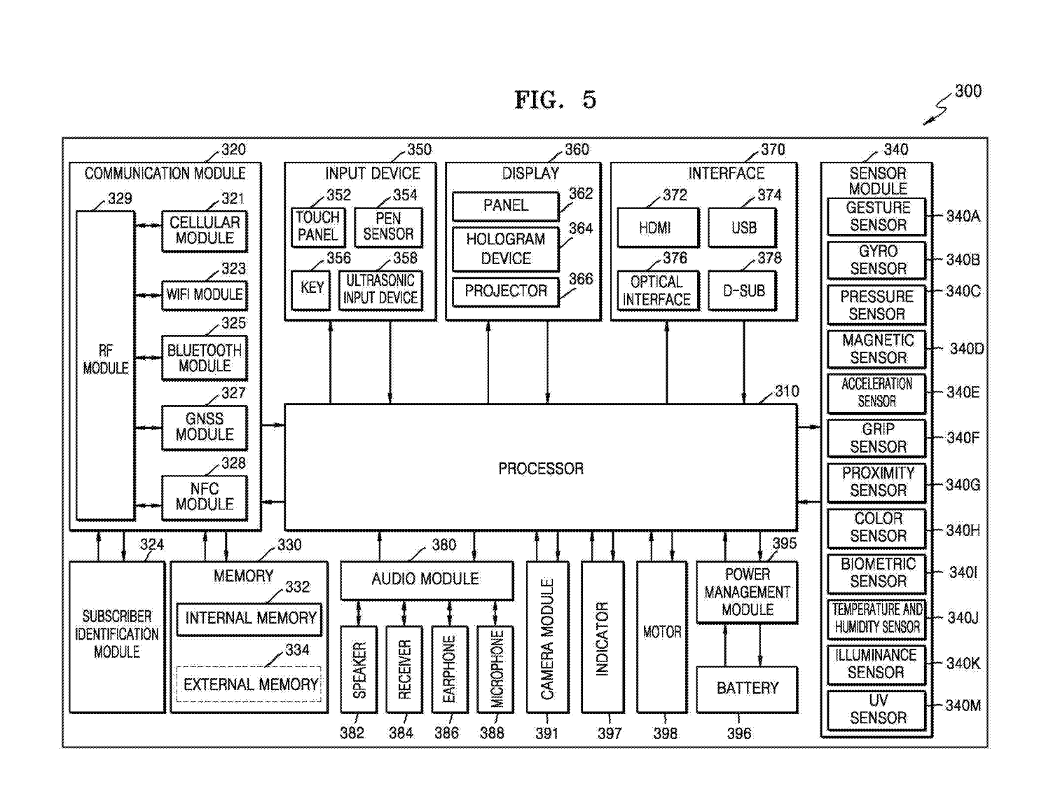

FIG. 5 is a block diagram illustrating an example configuration of a photographing device.

Referring to FIG. 5, a photographing device 300 may include one or more processors (e.g., an application processor (AP)) 310, a communication module 320, a subscriber identification module (SIM) 324, a memory 330, a sensor module 340, an input device 350, a display 360, an interface 370, an audio module 380, a camera module 391, a power management module 395, a battery 396, an indicator 397, and a motor 398.

Since the camera module 391 of FIG. 5 corresponds to the first camera module 110 and the second camera module 120 and the processor 310 of FIG. 5 corresponds to the controller 130 of FIG. 3A, the descriptions thereof will not be repeated.

By running, for example, an OS or an application program, the processor 310 may be configured to control a plurality of hardware or software elements connected thereto and perform a variety of data processing and calculations. The processor 310 may be implemented as, for example, a system on chip (SoC). The processor 310 may further include a graphics processing unit (GPU) and/or an ISP. The processor 310 may include at least some (e.g., a cellular module 321) of the elements illustrated in FIG. 5. The processor 310 may load an instruction or data received from at least one (e.g., a non-volatile memory) of other elements into a volatile memory and store various data in the non-volatile memory.

The communication module 320 may include, for example, the cellular module 321, a wireless fidelity (WiFi) module 323, a Bluetooth (BT) module 325, a global navigation satellite system (GNSS) module 327 (e.g., a global positioning system (GPS) module, a Globalnaya navigatsionnaya sputnikovaya sistema (GLONASS) module, a BeiDou module, or a Galileo module), a near field communication (NFC) module 328, and a radio frequency (RF) module 329.

The memory 330 may include, for example, an internal memory 332 and/or an external memory 334. The internal memory 332 may include, for example, at least one of a volatile memory (e.g., a dynamic RAM (DRAM), a static RAM (SRAM), a synchronous dynamic RAM (SDRAM), etc.), and a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, etc.), a hard disk drive, and a solid state drive (SSD)).

The external memory 334 may include a flash drive, for example, a compact flash (CF) memory card, an SD memory card, a micro-SD memory card, a mini-SD memory card, an extreme digital (XD) memory card, a multimedia card (MMC), a memory stick, and so on. Through various interfaces, the external memory 334 may be connected to the photographing device 300 functionally and/or physically.

The sensor module 340 may, for example, measure a physical quantity or sense an operational state of the photographing device 300 and convert the measured or sensed information into an electrical signal. The sensor module 340 may include at least one of, for example, a gesture sensor 340A, a gyro sensor 340B, an atmospheric pressure sensor 340C, a magnetic sensor 340D, an acceleration sensor 340E, a grip sensor 340F, a proximity sensor 340G, a color sensor 340H (e.g., an RGB sensor), a biometric sensor 340I, a temperature/humidity sensor 340J, an illuminance sensor 340K, and an ultraviolet (UV) sensor 340M. The sensor module 340 may further include a control circuit for controlling one or more sensors belonging thereto. The photographing device 300 may further include a processor configured to control the sensor module 340 as a part of the processor 310 or as a separate processor, thereby controlling the sensor module 340 while the processor 310 is in the sleep state.

The input device 350 may include, for example, a touch panel 352, a (digital) pen sensor 354, a key 356, or an ultrasonic input device 358. The touch panel 352 may use one or more of, for example, capacitive, resistive, infrared, and ultrasonic techniques, or the like. Also, the touch panel 352 may further include a control circuit. The touch panel 352 may further include a tactile layer to provide a tactile reaction to the user.

The (digital) pen sensor 354 may be, for example, a part of a touch panel or may include, for example, a separate recognition sheet. The key 356 may include, for example, physical buttons, optical keys, or a keypad. The ultrasonic input device 358 may sense an ultrasonic wave generated by an input tool through a microphone (e.g., a microphone 388), so that data corresponding to the sensed ultrasonic wave may be checked.

The display 360 may include a panel 362, a hologram device 364, or a projector 366. The panel 362 may be implemented to be, for example, flexible, transparent, or wearable. The panel 362 may constitute one module with the touch panel 352.

The interface 370 may include, for example, a high-definition multimedia interface (HDMI) 372, a universal serial bus (USB) 374, an optical interface 376, or a D-subminiature (D-sub) 378.

The audio module 380 may convert, for example, a sound into an electrical signal and vice versa. The audio module 380 may process sound information input or output through, for example, a speaker 382, a receiver 384, an earphone 386, the microphone 388, and so on.

The camera module 391 is, for example, a device capable of taking a still image or a video. The camera module 391 may include one or more image sensors (e.g., a front sensor and a rear sensor), a lens, an ISP, and a flash (e.g., a light-emitting diode (LED), a xenon lamp, etc.). The camera module 391 may include a first camera module and a second camera module which have been described above with reference to FIGS. 3A, 3B, and 4.

The power management module 395 may manage, for example, the power of the photographing device 300. The power management module 395 may include a power management integrated circuit (PMIC), a charger IC, or a battery or fuel gauge. The PMIC may employ a wired and/or wireless charging method. The battery gauge may measure, for example, the residual power, charging voltage, current, or temperature of the battery 396.

The indicator 397 may display a particular state, for example, a booting state, a message state, a charging state, etc., of the photographing device 300 or a part (e.g., the processor 310) of the photographing device 300. The motor 398 may convert an electrical signal into mechanical vibration and cause a vibration, haptic effects, and so on.

Each of the elements described herein may be configured as one or more components, and the name of the corresponding element may vary according to the type of the photographing device.

The block diagrams of the photographing devices 100, 200, and 300 illustrated in FIGS. 3A, 3B, 4, and 5 illustrate example embodiments. In various example embodiments, a photographing device may be configured to include at least one of the elements described herein. Some elements may be omitted, or other elements may be additionally included. Also, some of the elements of the photographing device may be combined into one entity, whose constituent elements may perform the same functions as before the combination.

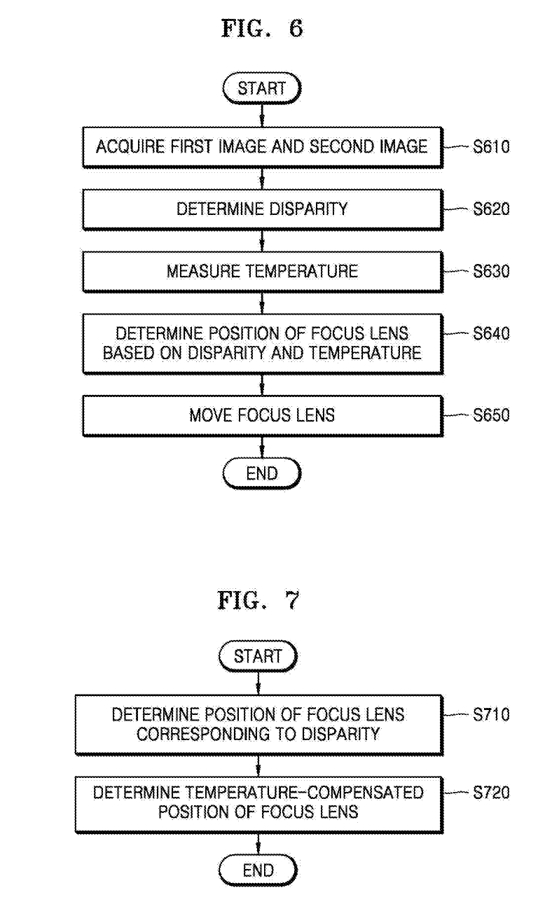

FIG. 6 is a flowchart illustrating an example method of a photographing device performing auto-focusing.

Referring to FIG. 6, the photographing device 100 may acquire a first image from the first camera module 110 and acquire a second image from the second camera module 120 (S610).

For example, the first image and the second image may be preview images which are acquired to show an image of a subject which is a target of photography to the user before the photography.

The photographing device 100 may determine a disparity using the first image and the second image (S620).

For example, the photographing device 100 may determine a disparity which is the difference between a position of a region of interest in the first image and a position of the region of interest in the second image. For example, the region of interest may be a region designated by the user. Alternatively, the photographing device 100 may detect a region including a particular object such as a person's face and set the detected region as the region of interest.

The region of interest in the first image and the region of interest in the second image may be regions including the same subject. As described above with reference to FIG. 1B, due to the difference in position between the first camera module 110 and the second camera module 120, the positions of the same subject in the first image and the second image are different, and a disparity is caused.

The photographing device 100 may measure the temperature of the first camera module 110 and the temperature of the second camera module 120 (S630).

For example, using temperature sensors, the photographing device 100 may measure the temperatures of lenses included in the first camera module 110 and the second camera module 120. Also, using humidity sensors, the photographing device 100 may measure the humidities of the lenses included in the first camera module 110 and the second camera module 120.

Based on the disparity determined in operation 620 (S620) and the temperature of the first camera module 110 measured in operation 630 (S630), the photographing device 100 may determine the position of a focus lens included in the first camera module 110 (S640). Based on the disparity and the temperature of the second camera module 120, the photographing device 100 may also determine the position of a focus lens included in the second camera module 120.

FIG. 7 is a flowchart illustrating operation 640 (S640) of FIG. 6 in greater detail. Operation 640 (S640) will be described in greater detail below with reference to FIG. 7.

Referring to FIG. 7, the photographing device 100 may determine the distance between the first camera module 110 and the subject which is the target of photography using the disparity. The photographing device 100 may also determine the position of the focus lens for focusing on the subject based on the distance to the subject (S710).

Using a disparity map, for example, the photographing device 100 may convert the determined disparity into the position of the focus lens. The disparity map may be pre-stored in the photographing device 100. The disparity map may be a table showing positions of focus lenses (the focus lenses included in the first camera module 110 and the second camera module 120) each corresponding to each of a plurality of disparities. The positions of the focus lenses included in the disparity map may be positions measured during manufacturing of the photographing device 100, for example, positions of the focus lenses corresponding to temperature and humidity at which the manufacturing process is carried out. Alternatively, the disparity map may be in the form of a relational expression for converting a disparity into the position of the focus lens included in the first camera module 110 or a relational expression for converting a disparity into the position of the focus lens included in the second camera module 120. However, the disparity map is not limited thereto.

As described above, when a disparity map is constructed based on positions of focus lenses measured during the manufacturing process, positions of the focus lenses converted based on the disparity map are positions of the focus lenses corresponding to temperature and humidity at which the manufacturing process is carried out.

The photographing device 100 may perform temperature compensation of the position determined in operation 710 (S710) according to the current temperature (S720).

For example, using a temperature map, the photographing device 100 may convert the position of the focus lens corresponding to the disparity into a position of the focus lens corresponding to the current temperature. The temperature map may be a table for converting a calculated position of a focus lens (e.g., a position of the focus lens corresponding to the temperature at which the manufacturing process is carried out) into a position of the focus lens corresponding to the current temperature.

Alternatively, using a temperature compensation equation, the photographing device 100 may convert the position of the focus lens corresponding to the disparity into a position of the focus lens corresponding to the current temperature. An example temperature compensation equation Equation 1 is illustrated below.

Depth AF_{c}=Depth AFₒ+(Temp×C1−C0) [Equation 1]

Here, Depth AF_{c} represents a position of the focus lens corresponding to the current temperature, and Depth AFₒ represents a position of the focus lens converted based on the disparity map (e.g., the position of the focus lens corresponding to the temperature at which the manufacturing process is carried out). Temp represents the current temperature, C0 represents a first temperature compensation coefficient, and C1 represents a second temperature compensation coefficient.

Referring back to FIG. 6, by moving the focus lens to the position of the focus lens obtained through the temperature compensation, the photographing device 100 may perform auto-focusing to focus on the region of interest (S650). When the auto-focusing is performed, the photographing device 100 photographs the subject.

Although FIGS. 6 and 7 illustrate only one example embodiment of determining a position of a focus lens based on a determined disparity and the temperature of a camera module, the photographing device 100 may determine a position of a focus lens based on a determined disparity and the humidity of a camera module.

For example, the photographing device 100 may convert a determined disparity into a position of a focus lens using a disparity map and perform a humidity compensation of the converted position of the focus lens based on the current humidity. Using a humidity map in the same way a temperature map is used, it is possible to convert the position of the focus lens corresponding to the disparity into a position of the focus lens corresponding to the current humidity. The humidity map may include a table or equation for converting a calculated position of a focus lens into a position of the focus lens corresponding to the current humidity.

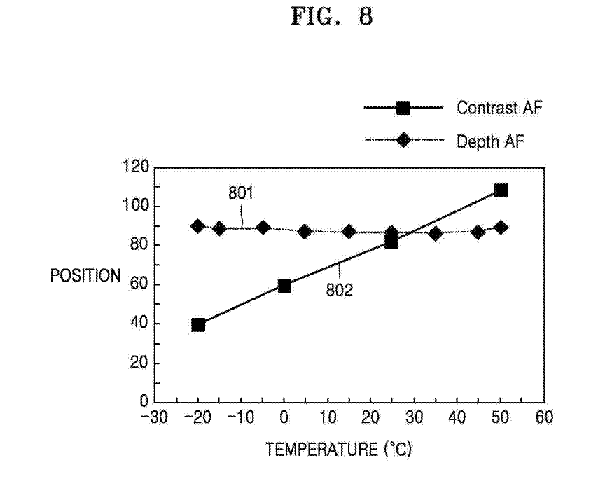

FIG. 8 is a graph illustrating an example position of a focus lens determined using the depth auto-focus scheme and a position of the focus lens determined using a contrast auto-focus scheme with respect to a subject which is a constant distance away from a camera module based on the temperature of the camera module.

A dotted-line graph 801 of FIG. 8 represents a position of a focus lens determined using the depth auto-focus scheme, and a solid-line graph 802 represents a position of the focus lens determined using the contrast auto-focus scheme.

According to the contrast auto-focus scheme, images are acquired while the position of a focus lens is changed, and the position of the focus lens corresponding to an image having the largest contrast value among the acquired images is determined as the final position of the focus lens. Auto-focusing with the contrast auto-focus scheme shows higher auto-focusing accuracy but slower auto-focusing speed than auto-focusing with the depth auto-focus scheme.

Referring to the solid-line graph 802 of FIG. 8, the contrast auto-focus scheme reflects a characteristic of a camera module which is that the focal length is changed based on the temperature of the camera module (the temperature of a lens) and a position of the focus lens determined according to the temperature of the camera module varies. On the other hand, referring to the dotted-line graph 801 of FIG. 8, the depth auto-focus scheme does not reflect the characteristic of a camera module that the focal length is changed based on the temperature of the camera module (the temperature of a lens) and positions of the focus lens determined based on the temperature of the camera module are substantially identical.

However, at a temperature at which positions of the focus lens included in a disparity map have been measured (e.g., a temperature at which the manufacturing process of the photographing device 100 has been performed), the position of the focus lens determined with the depth auto-focus scheme and the position of the focus lens determined with the contrast auto-focus scheme may be substantially identical.

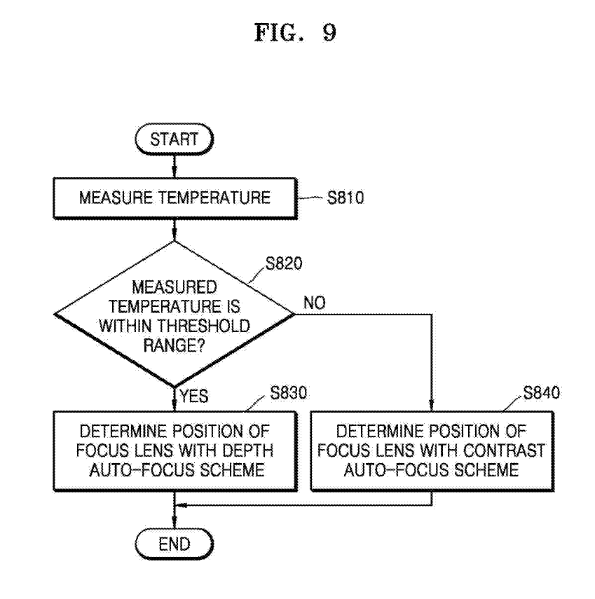

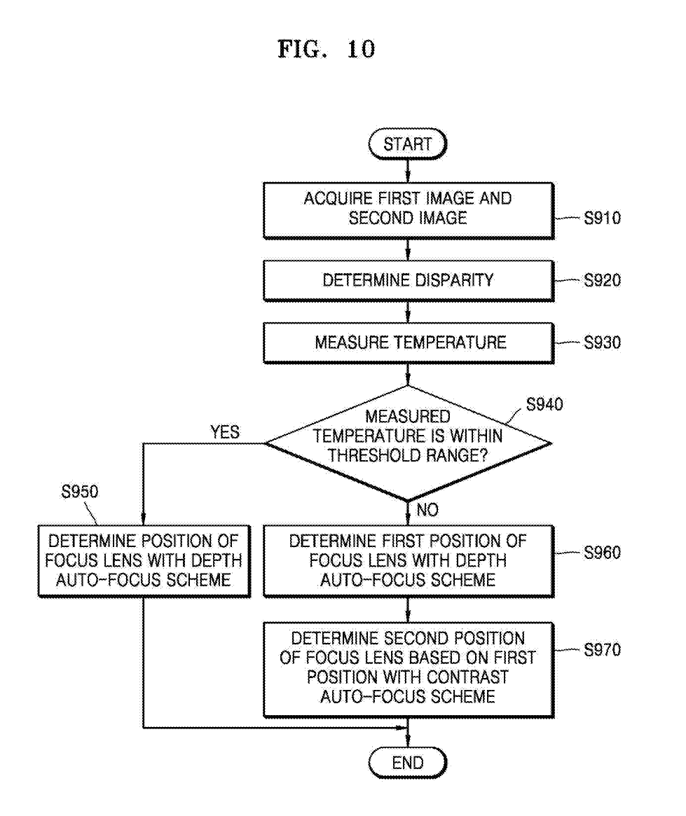

In a certain range (threshold range) of temperature, the range of error between the position of the focus lens determined with the depth auto-focus scheme and the position of the focus lens determined with the contrast auto-focus scheme may be small. Accordingly, the photographing device 100 may perform hybrid auto-focusing by determining a position of the focus lens with the depth auto-focus scheme in the threshold range of temperature and determining a position of the focus lens with the contrast auto-focus scheme in a range of temperature outside the threshold range. This will be described in greater detail below with reference to FIGS. 9 and 10.

FIG. 9 is a flowchart illustrating an example method of a photographing device performing auto-focusing.

Referring to FIG. 9, the photographing device 100 may measure the temperatures of the first camera module 110 and the second camera module 120 (S810).

For example, using temperature sensors, the photographing device 100 may measure the temperatures of lenses included in the first camera module 110 and the second camera module 120. Also, using humidity sensors, the photographing device 100 may measure the humidities of the lenses included in the first camera module 110 and the second camera module 120.

The photographing device 100 may determine whether a measured temperature is included in a first threshold range (S820).

The first threshold range may be a temperature range in which the focal length of a camera module is not significantly changed based on temperature or a change in the focal length based on temperature is smaller than a certain value. The first threshold may include the temperature at which the manufacturing process of the photographing device 100 has been performed.

Alternatively, the photographing device 100 may determine whether a measured temperature is included in a second threshold range. The second threshold range may be a humidity range in which the focal length of a camera module is not significantly changed based on humidity or a change in the focal length based on humidity is smaller than a certain value. The second threshold may include the humidity at which the manufacturing process of the photographing device 100 has been performed.

When the measured temperature is included in the first threshold range, the photographing device 100 may determine a position of the focus lens with the depth auto-focus scheme (S830). Alternatively, when the measured humidity is included in the second threshold range, the photographing device 100 may determine a position of the focus lens with the depth auto-focus scheme.

According to the depth auto-focus scheme, as described above, a disparity of a subject is determined using images acquired from the first camera module 110 and the second camera module 120, and a position of a focus lens corresponding to the determined disparity is acquired. Using a disparity map, a camera module may detect the position of the focus lens corresponding to the determined disparity.

When the measured temperature is not included in the first threshold range, the photographing device 100 may determine a position of the focus lens with the contrast auto-focus scheme (S840). Alternatively, when the measured humidity is not included in the second threshold range, the photographing device 100 may calculate a position of the focus lens with the contrast auto-focus scheme.

According to the contrast auto-focus scheme, a position of a focus lens is acquired based on contrasts of images acquired from camera modules. For example, a camera module may acquire a plurality of images while changing a position of a focus lens. The camera module detects an image having the largest contrast value among the acquired images. The camera module may determine a position of the focus lens corresponding to the detected image as the final position of the focus lens.

By moving the focus lens to the position of the focus lens determined with the depth auto-focus scheme in operation 830 (S830) or the position of the focus lens determined with the contrast auto-focus scheme in operation 840 (S840), the photographing device 100 may focus on a subject.

FIG. 10 is a flowchart illustrating an example method of a photographing device performing auto-focusing.

Referring to FIG. 10, the photographing device 100 may acquire a first image from the first camera module 110 and acquire a second image from the second camera module 120 (S910).

For example, the first image and the second image may be preview images which are acquired to show an image of a subject which is a target of photography to the user before the photography.

The photographing device 100 may determine a disparity using the first image and the second image (S920).

For example, the photographing device 100 may determine a disparity which is the difference between a position of a region of interest in the first image and a position of the region of interest in the second image. The region of interest in the first image and the region of interest in the second image may be regions including the same subject.

The photographing device 100 may measure the temperature of the first camera module 110 and the temperature of the second camera module 120 (S930).

For example, using temperature sensors, the photographing device 100 may measure the temperatures of lenses included in the first camera module 110 and the second camera module 120. Using humidity sensors, the photographing device 100 may measure the humidities of the lenses included in the first camera module 110 and the second camera module 120.

The photographing device 100 may determine whether a measured temperature is included in a first threshold range (S940). Alternatively, the photographing device 100 may determine whether a measured humidity is included in a second threshold range. The first threshold range and the second threshold range have been described in detail above in operation 820 (S820) of FIG. 9, and the descriptions will not be repeated.

When the measured temperature is included in the first threshold range, the photographing device 100 may determine a position of a focus lens with the depth auto-focus scheme (S950). Alternatively, when the measured humidity is included in the second threshold range, the photographing device 100 may calculate the position of the focus lens with the depth auto-focus scheme.

When the measured temperature is not within in the first threshold range, the photographing device 100 may determine a first position of the focus lens with the depth auto-focus scheme (S960). Within a certain range based on the determined first position, the photographing device 100 may determine a second position of the focus lens with the contrast auto-focus scheme (S970).

The photographing device 100 may determine a certain range in which the position of the focus lens will be changed based on the first position. The certain range in which the position of the focus lens will be changed is narrower than a whole range in which the position of the focus lens is changeable. For example, when the position of the focus lens is changeable in the range of 0 to 150 and the first position of the focus lens determined with the depth auto-focus scheme is 80, the photographing device 100 may determine the certain range in which the position of the focus lens will be changed to be 60 to 100. While changing the position of the focus lens between 60 and 100 by a certain value, the photographing device 100 may acquire images. The photographing device 100 detects an image having the largest contrast value among the images acquired at respective changed positions. The photographing device 100 may determine a position corresponding to the detected image as the final position (second position) of the focus lens.

As described in operation 960 (S960) and operation 970 (S970), even when the measured humidity is not included in the second threshold range, the photographing device 100 may determine a first position of the focus lens with the depth auto-focus scheme and determine a second position of the focus lens with the contrast auto-focus scheme within the certain range based on the determined first position.

An method of operating a photographing device may be embodied in the form of program instructions executable by various computing tools and recorded in a computer-readable recording medium. The computer-readable recording medium may include program instructions, data files, data structures, etc., alone or in combination. The program instructions recorded in the computer-readable recording medium may be specially designed or configured for the present disclosure or may be known to and used by those of ordinary skill in the computer software art. Examples of the computer-readable recording medium include magnetic media, such as a hard disk, a floppy disk, and a magnetic tape, optical media, such as a CD-ROM and a DVD, magneto-optical media, such as a floptical disk, and hardware devices, such as a ROM, a RAM, a flash memory, etc., specially configured to store and execute the program instructions. Examples of the program instructions include a high-level language code executable by a computer using an interpreter, etc. as well as a machine language code created by a compiler.

According to an example embodiment, a position of a focus lens determined with the depth auto-focus scheme is corrected using a temperature measured from each camera module, so that the accuracy of auto-focusing may be improved.

Auto-focusing may also performed using the depth auto-focus scheme mixed with the contrast auto-focus scheme based on the temperature of each camera module, so that the auto-focusing speed may be increased and the accuracy may be improved.

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. A photographing device comprising:
a first camera module comprising a first camera and second camera module comprising a second camera, the first and second camera modules configured to photograph a same subject;
a temperature sensor configured to measure a temperature of the first camera module; and
a controller configured to determine a disparity between a first image acquired from the first camera module and a second image acquired from the second camera module and to perform auto-focusing of the first camera module based on the disparity and the temperature of the first camera module.

2. The photographing device of claim 1, wherein the controller is configured to perform the auto-focusing to focus the first camera module on the subject.

3. The photographing device of claim 1, wherein the first camera module includes a focus lens, and
the temperature of the first camera module is a temperature of the focus lens.

4. The photographing device of claim 3, wherein the controller is configured to determine a first position of the focus lens corresponding to the disparity, to determine a second position of the focus lens by performing temperature compensation of the first position based on the temperature of the first camera module, and to control the photographing device to move the focus lens to the second position.

5. The photographing device of claim 4, further comprising:
a storage configured to store a disparity map representing a relationship between the disparity and a position of the focus lens and a temperature map representing a relationship between the position of the focus lens and the temperature of the first camera module,
wherein the controller is configured to determine the first position corresponding to the disparity using the disparity map and to convert the first position into the second position using the temperature map.

6. The photographing device of claim 3, wherein the focus lens includes a plastic lens.

7. The photographing device of claim 3, wherein the controller is configured to compare the temperature of the first camera module with a threshold range, to determine a position of the focus lens based on the disparity when the temperature of the first camera module is included in the threshold range, and when the temperature of the first camera module is not included in the threshold range, to acquire a plurality of images while changing the position of the focus lens and determine the position of the focus lens based on contrasts of the plurality of images.

8. The photographing device of claim 7, wherein, when the temperature of the first camera module is not included in the threshold range, the controller is configured to determine a first position of the focus lens based on the disparity, to acquire the plurality of images while changing the position of the focus lens within a certain range determined based on the first position, and to determine a second position of the focus lens based on contrasts of the plurality of images.

9. The photographing device of claim 1, further comprising:
a humidity sensor configured to measure humidity of the first camera module,
wherein the controller is configured to perform the auto-focusing of the first camera module based on the disparity and the humidity of the first camera module.

10. A method of operating a photographing device, the method comprising:
acquiring a first image of a subject from a first camera module and acquiring a second image of the subject from a second camera module;
determining a disparity between the first image and the second image;
measuring a temperature of the first camera module; and
performing auto-focusing of the first camera module based on the disparity and the temperature of the first camera module.

11. The method of claim 10, wherein the performing of the auto-focusing of the first camera module comprises focusing the first camera module on the subject.

12. The method of claim 10, wherein the first camera module includes a focus lens, and
the measuring of the temperature of the first camera module comprises measuring a temperature of the focus lens.

13. The method of claim 12, wherein the performing of the auto-focusing of the first camera module comprises:
determining a first position of the focus lens corresponding to the disparity;
determining a second position of the focus lens by performing temperature compensation of the first position based on the temperature of the first camera module; and
moving the focus lens to the second position.

14. The method of claim 13, further comprising:
storing a disparity map representing a relationship between the disparity and a position of the focus lens and a temperature map representing a relationship between the position of the focus lens and the temperature of the first camera module,
wherein the determining of the first position comprises determining the first position corresponding to the disparity using the disparity map, and
the determining of the second position comprises converting the first position into the second position using the temperature map.

15. The method of claim 12, wherein the performing of the auto-focusing of the first camera module comprises:
comparing the temperature of the first camera module with a threshold range;
determining a position of the focus lens based on the disparity when the temperature of the first camera module is within in the threshold range; and
acquiring a plurality of images while changing the position of the focus lens and determining the position of the focus lens based on contrasts of the plurality of images when the temperature of the first camera module is not within the threshold range.

16. The method of claim 15, wherein, when the temperature of the first camera module is not included in the threshold range, the determining of the position of the focus lens comprises:
determining a first position of the focus lens based on the disparity; and
acquiring the plurality of images while changing the position of the focus lens within a certain range determined based on the first position and determining a second position of the focus lens based on contrasts of the plurality of images.

17. The method of claim 10, further comprising:
measuring a humidity of the first camera module; and
performing the auto-focusing of the first camera module based on the disparity and the humidity of the first camera module.

18. A non-transitory computer-readable recording medium storing a program which, when executed by a processor, causes a photographing apparatus to perform the operations recited in claim 10.
